(19) United States
(12) Patent Application Publication
(10) Pub. No.: US 2009/0040277 A1
(43) Pub. Date: Feb. 12, 2009

(54) INKJET IMAGE FORMING APPARATUS

(75) Inventors: Eun Bong HAN, Suwon-si (KR); Nam Kyun KIM, Seongnam-si (KR); Tae Jin KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/117,125

(22) Filed: May 8, 2008

(30) Foreign Application Priority Data
Aug. 6, 2007 (KR) 2007-78442

(51) Int. Cl. B41J 2/05

(52) U.S. Cl. 347/57

(57) ABSTRACT

An inkjet image forming apparatus includes a simulation driving circuit having the same characteristics as a driving circuit of a heater corresponding to several nozzles in a head-chip. The inkjet image forming apparatus adjusts a driving power-supply signal applied to a pre-driver to drive an nMOSFET connected to the heater using the simulation driving circuit, and acquires information of additional resistance compensating for a heater driving current. The inkjet image forming apparatus performs a printing process using the acquired additional resistance information, resulting in implementation of a superior print quality.

### CROSS-REFERENCE TO RELATED APPLICATIONS

This application claims priority under 35 U.S.C. §119(a) from Korean Patent Application No. 2007-0078442, filed on Aug. 6, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus to establish a heater driving condition using a simulation driving circuit contained in a head chip, and a method to control the same.

2. Description of the Related Art

Generally, the inkjet print head applied to an inkjet image forming apparatus can be classified into a thermal-driving inkjet printer head based on the injection mechanism of ink bubbles and an inkjet printer head based on a piezoelectric driving scheme. The ink-bubbles injection mechanism of the inkjet printer head based on the thermal-driving scheme will hereinafter be described.

If a pulse-shaped current signal flows in a heater composed of a resistance-heating material, the heater generates heat, so that ink adjacent to the heater is instantaneously heated up to about 300° C. Therefore, ink bubbles occur, the bubbles are increased, so that the increased bubbles apply pressure to an inside of an ink chamber fully filled with the ink. The ink adjacent to the nozzle is configured in a form of ink bubbles via the nozzle, and ink droplets are sprayed out of the ink chamber.

The ink injection amount of the inkjet print head is greatly changed according to a variety of factors, for example, a heater driving condition and an inner temperature of the print head.

Specifically, if the heater driving condition is changed, this changed condition affects a process for forming bubbles by boiling ink.

Recently, a variety of array-head-structured image forming apparatuses, which print a desired image at a high speed without generating right/left movement of the printer head using a printer head, have been developed to implement the high-speed and high-quality image printing. In this case, the printer head includes an inkjet head chip having a same width as that of a medium to be printed. The array-head-structured image forming apparatus includes a plurality of heaters in a head chip of the printer head printing an image on a medium.

Generally, a large amount of power is required to drive a large number of heaters, so that a time-sharing driving scheme (also called a time-division driving scheme) has been widely used. This time-sharing driving scheme divides the heaters into a plurality of groups, and sequentially drives the group heaters.

The time-sharing driving scheme selectively drives a group from among the above-mentioned groups using primitive data, and selects heaters to be driven from among the heaters contained in the respective group using address data.

Since at least one heater can be driven for each group, simultaneously-driven heaters may exist in an entire group, and several groups may simultaneously drive several heaters.

With the increasing development of a semiconductor fabrication technology, a line width of a circuit becomes narrower, and a transistor size becomes smaller. Although each inkjet head chip includes a heater driving circuit to apply a pulse current signal to a heater, a power-supply wiring to drive the heater and a ground wiring are shared to further reduce an overall size of the head chip.

If the head chip shares the heater power-supply circuit, a difference in a driving current signal flowing in individual heaters occurs according to a number of driven heaters and a heater location associated with a power-supply unit, so that the heater driving condition is unavoidably changed. As a result, the changed heater driving condition has a negative influence upon ink-discharging characteristics, resulting in a reduction of a printing quality.

### SUMMARY OF THE INVENTION

The present general inventive concept provides an inkjet image forming apparatus to properly cope with a change of a heater driving condition based on printer-head characteristics, thereby preventing a printing quality from being deteriorated.

Additional aspects and/or utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an inkjet image forming apparatus including a print-head chip having a heater driving circuit to drive a plurality of heaters corresponding to a plurality of nozzles, and a simulation driving circuit to perform a simulation test using a specific circuit modeled on the heater driving circuit to compensate for a difference in heater driving current flowing in each heater according to a number of simultaneously-driven heaters associated with the plurality of heaters and locations of the heaters.

The simulation driving circuit may be provided in the print-head chip.

The simulation driving circuit may vary a driving power-supply signal provided to a driver to drive a transistor connected to each heater in order to perform the simulation test.

The transistor may be an nMOSFET.

The driving power-supply signal provided to the driver may be located separately from a heater-driving power-supply signal to drive each heater.

The driver may change a voltage signal applied to a gate of the nMOSFET according to the received driving power-supply signal.

The simulation driving circuit may include a simulation power-supply wiring circuit modeled on the heater driving circuit, a decoder to change the driving power-supply signal, and to provide the changed driving power-supply signal, a simulation power-supply wiring analyzer to generate specific information which establishes a heater resistance and an additional resistance added to an ON-resistance of the transistor according to the number of simultaneously-driven heaters and the locations of the heaters, while the driving power-supply signal is changed, and a memory to store information associated with the additional resistance.

The simulation power-supply wiring circuit may allow individual heater resistances corresponding to the heater to share a power-supply wiring and a ground wiring, and the power-supply wiring and the ground wiring are configured by reducing a width and a length of a real wiring by a predetermined ratio.

The foregoing and/or other aspects and utilities of the general inventive concept may also be achieved by providing a method to control an inkjet image forming apparatus which includes a heater driving circuit to drive a plurality of heaters corresponding to a plurality of nozzles, and a simulation driving circuit contained in a head chip, to perform a simulation test using a specific circuit modeled on the heater driving circuit, the method including determining if a current mode is an operation mode, and if the operation mode is determined, acquiring specific information of an additional resistance added to each heater, in order to compensate for a variation in heater driving condition which is changed according to a number of simultaneously-driven heaters corresponding to the plurality of heaters and locations of the heaters using the simulation driving circuit, and storing the acquired information of the additional resistance.

The determining of the operation mode may include if the head chip is exchanged or repaired while an initial power-supply signal is provided to a system, determining the operation mode for the simulation test.

The acquiring of the additional resistance information may include changing a driver's driving power-supply signal applied to a gate of an nMOSFET connected to the heater.

The method may further include establishing a driving power-supply signal of the driver according to the additional resistance read from information stored according to print data provided for a print process.

The inkjet image forming apparatus according to various embodiments of the present general inventive concept can establish additional resistance affected by a number of driven heaters and the heater location using a simulation driving circuit contained in a head chip, and can properly compensate for the heater driving current to prevent the negative influence on ink-discharging characteristics, resulting in an implementation of a superior printing quality.

The foregoing and/or other aspects and utilities of the general inventive concept may also be achieved by providing an inkjet image forming apparatus including a heater driving circuit disposed on a head chip, and a simulation driving circuit to compensate for a change of a heater driving condition based on one or more printer-head characteristics.

The simulation driving circuit may compensate for the change of the heater driving condition by variably establishing the additional resistance corresponding to a number of driven heaters and heater locations.

The foregoing and/or other aspects and utilities of the general inventive concept may also be achieved by providing a method of operating an inkjet image forming apparatus, the method including identifying one or more printer-head characteristics, and compensating for a change of a heater driving condition based on the identified one or more printer-head characteristics by variably establishing additional resistance corresponding to a number of driven heaters and heater locations.

The foregoing and/or other aspects and utilities of the general inventive concept may also be achieved by providing a computer-readable recording medium having embodied thereon a computer program to execute a method, wherein the method includes identifying one or more printer-head characteristics, and compensating for a change of a heater driving condition based on the identified one or more printer-head characteristics by variably establishing additional resistance corresponding to a number of driven heaters and heater locations.

The foregoing and/or other aspects and utilities of the general inventive concept may also be achieved by providing a method of operating an inkjet image forming apparatus, the method including applying a request to adjust a driving power-supply signal based on a number of driven heaters and respective heater locations to a decoder, separately varying the driving power-supply signal, applying digital-formatted heater driving current information to a simulation power-supply wiring analyzer, acquiring and storing additional resistance information on a basis of the applied heater driving current information to memory, receiving printing data from a logic unit, and analyzing the number of heaters required to print the printing data and the respective heater locations.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a conceptual diagram illustrating a heater driving circuit contained in a logic circuit of a general head chip according to an embodiment of the present general inventive concept;

FIG. 2 is a modeling diagram illustrating a power-supply line resistance corresponding to a plurality of small-sized groups contained in a first large-sized group according to an embodiment of the present general inventive concept;

FIG. 3 is a driving current associated with the heater driving for each small-sized heater sum resistance of FIG. 2 according to an embodiment of the present general inventive concept;

FIG. 4 is a detailed circuit diagram illustrating a circuit to drive a heater corresponding to a nozzle of a head-chip applied to the inkjet image forming apparatus according an embodiment of to the present general inventive concept;

FIG. 5 is a graph illustrating operation characteristics of an nMOSFET to drive the heater of FIG. 4 according to an embodiment of the present general inventive concept;

FIG. 6 is a modeling diagram illustrating a power-supply line resistance corresponding to a plurality of small-sized groups contained in a first large-sized group applied to a head-chip according to an embodiment of the present general inventive concept;

FIG. 7 exemplarily illustrates a process to establish additional resistances of a plurality of small-sized groups according to a number of simultaneously-driven heaters and locations of the heaters according to an embodiment of the present general inventive concept;

FIG. 8 is a modeling diagram illustrating a simulation driving circuit according to an embodiment of the present general inventive concept; and

FIG. 9 is a block diagram illustrating an inkjet image forming apparatus according an embodiment of to the present general inventive concept

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below to explain the present inventive concept by referring to the figures.

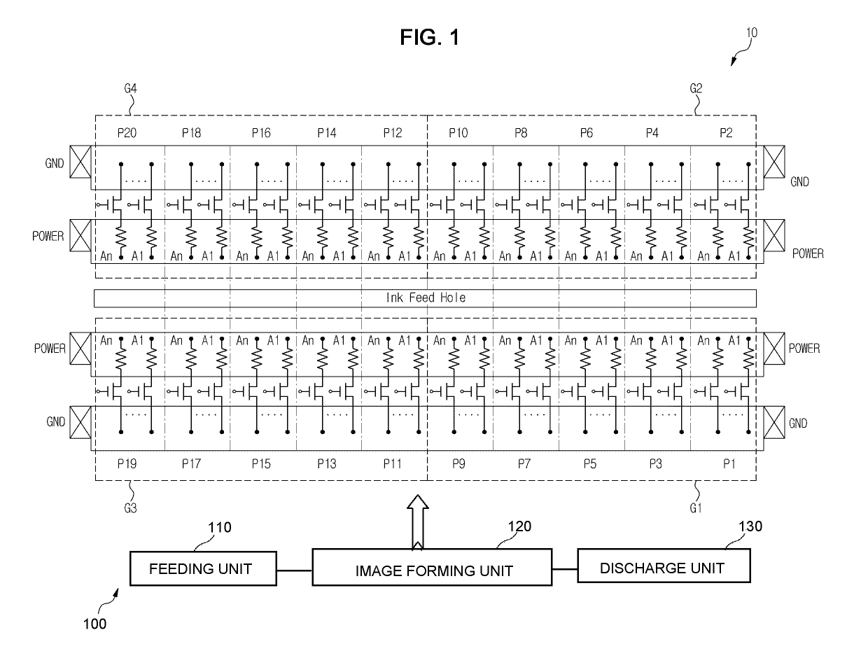

FIG. 1 is a conceptual diagram illustrating a heater driving circuit contained in a logic circuit of a head chip 10 in an image forming apparatus 100 according to an embodiment of the present general inventive concept.

The image forming apparatus 100 includes a feeding unit 110 to feed a print medium, an image forming unit 120 to form an image on the fed print medium using the head chip 10, and a discharge unit 130 to discharge the print medium with the image.

Referring to FIG. 1, a head chip 10 based on the thermal-driving print head is divided into a plurality of small-sized groups (P1, P2, . . . , P19, and P20) in order to drive several heaters using a time-sharing driving scheme. In this embodiment, the plurality of small-sized groups may correspond to a primitive data group for the time-sharing driving scheme.

Each small-sized group includes a plurality of heater driving circuits (A1, . . . , An) corresponding to several nozzles. The small-sized groups share a power-supply wiring (POWER) and a ground wiring (GND) vertically arranged on a basis of an ink feed hole formed at a center of the head chip.

The small-sized groups (P1, P2, . . . , P19, and P20) can be divided into four large-sized groups (G1, G2, G3, and G4) having same circuit characteristics. A first large-sized group will hereinafter be described as one example of the four groups.

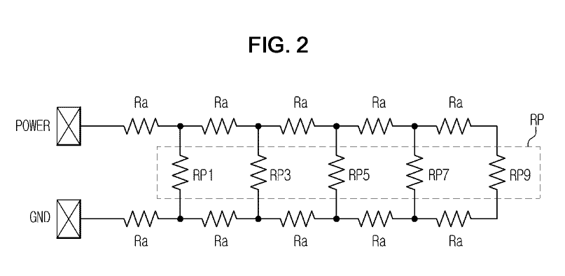

FIG. 2 is a modeling diagram illustrating a power-supply line resistance corresponding to a plurality of small-sized groups contained in a first large-sized group G1 of FIG. 1. In FIG. 2, “Ra” is indicative of a wiring resistance between the small-sized groups, and “RP” is indicative of a small-sized group heater resistor unit.

The small-sized group heater resistor unit (RP) includes a first small-sized group heater sum resistor (RP1) corresponding to a first small-sized group (P1), a third small-sized group heater sum resistor (RP3) corresponding to a third small-sized group (P3), a fifth small-sized group heater sum resistor (RP5) corresponding to a fifth small-sized group (P5), a seventh small-sized group heater sum resistor (RP7) corresponding to a seventh small-sized group (P7), and a ninth small-sized group heater sum resistor (RP9) corresponding to a ninth small-sized group (P9). Each sum resistor (RP1, RP3, RP5, RP7, or RP9) is indicative of a sum of a heater resistance and an ON-resistance (Rds) of a transistor (nMOSFET) to drive the heater. In this case, each sum resistor (RP1, RP3, RP5, RP7, or RP9) is a general term of several heaters corresponding to several nozzles contained in a corresponding small-sized group. Since the time-sharing driving scheme is applied to the above-mentioned resistors (RP1, RP3, RP5, RP7, and RP9), the resistors can simultaneously drive several heaters in different small-sized groups. However, it should be noted that a number of heaters simultaneously driven in each small-sized group is limited to only one.

As illustrated in FIG. 2, the small-sized group heater sum resistors contained in the small-sized group heater resistor unit (RP) share the power-supply wiring (POWER) and the ground wiring (GND), however, the small-sized group heater sum resistors are separated from the wiring (POWER) at different locations.

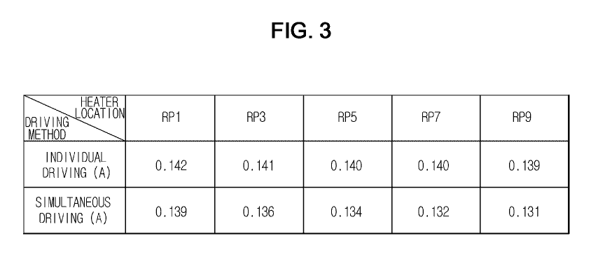

In association with a first case in which the individual small-sized group heater sum resistors are driven separately from each other and a second case in which the total small-sized group heater sum resistors are simultaneously driven, the present embodiment acquires a following test result illustrated in FIG. 3. As illustrated in FIG. 3, a difference in heater-driving current signal for each small-sized group heater sum resistor occurs.

For example, a difference between a heater driving current signal (0.142A) when only a first small-sized group heater sum resistor (RP1) closest to the POWER side is separately driven and the other heater driving current signal (0.139A) when only a ninth small-sized group heater sum resistor (RP9) most distant from the POWER side is separately driven is 3 mA.

For another example, if all the small-sized group heater sum resistors are simultaneously driven, a difference between a heater driving current signal (0.139A) flowing in a first small-sized group heater sum resistor (RP1) and the other heater driving current signal (0.131A) flowing in a ninth small-sized group heater sum resistor (RP9) is 8 mA. In this way, the total small-sized group heater sum resistors are simultaneously driven, the difference between the heater driving current signals is larger than that of the above-mentioned separated-driving case.

As described above, the time-sharing driving scheme has been adapted to print printing data, any one of small-sized groups may be separately driven or all the small-sized groups may be simultaneously driven as necessary. In this case, if the heater driving current is changed according to a number of simultaneously-driven heaters and relative locations of the heaters, the heater driving condition is also changed.

In the case of using the time-sharing driving scheme, provided that the inkjet image forming apparatus according to the present embodiment has difficulty in completely excluding a variation of the heater driving condition, there is needed a new method to properly cope with the variation of the heater driving condition.

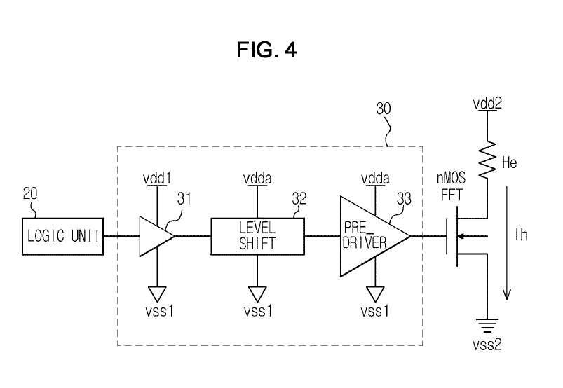

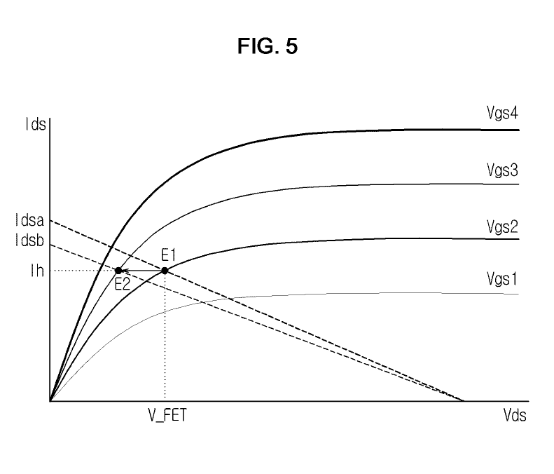

This embodiment aims to control the driving power-supply signal applied to the heater driving circuit so as to effectively cope with the variation of the heater driving condition, and will hereinafter be described with reference to FIGS. 4 and 5. FIG. 4 is a detailed circuit diagram illustrating a circuit to drive a heater corresponding to a nozzle of a head-chip applied to the inkjet image forming apparatus according to an embodiment of the present general inventive concept. FIG. 5 is a graph illustrating operation characteristics of an nMOSFET to drive the heater of FIG. 4 according to an embodiment of the present general inventive concept.

Referring to FIG. 4, the logic unit 20 contained in the head chip analyzes printing data received from a controller via a pad unit (not illustrated), and outputs a heater driving signal to a heater driving circuit to drive a heater (He) corresponding to either one of several nozzles to a heater driving circuit unit 30. In this case, although a single heater driving circuit unit to drive only one heater (He) is connected to the logic unit 20, the scope of the present general inventive concept is not limited to this example. Several nMOSFETs and several heater driving circuit units are connected in parallel to each other to drive the single heater (He), so that the logic unit may simultaneously drive all the parallel-connected components, or may selectively drive some of the components as necessary.

The heater driving circuit 30 includes a buffer 31, a level-shift 32, and a pre-driver 33. The buffer 31 temporarily stores and outputs the heater driving signal of the logic unit 20. The level-shift 32 shifts an output signal level to drive the heater (He) driven at a voltage (Vdd2) upon receiving a low-voltage signal from the buffer 31 driven at a voltage (Vdd1, where Vdd1<Vdd2). The pre-driver 33 amplifies the output signal of the level shift 32 to drive the nMOSFET connected to the heater (He).

In this case, in order to prevent erroneous operations from being generated by noise during the heater driving time, the level shift 32 and the pre-driver 33 use different driving power-supply voltages (Vdda) having a same level in the heater driving voltage (Vdd2).

If a minimum driving voltage (V_FET) is applied to a gate of the nMOSFET in the pre-driver 33, the nMOSFET is turned on, so that the heater driving current signal (ih) flows in the nMOSFET.

As for voltage-current characteristics of the nMOSFET, if a gate-source voltage (Vgs2) of the nMOSFET is established on a basis of the point E1 of FIG. 5, the gate-source voltage (Vgs2) is changed to another gate-source voltage (Vgs3) higher than the voltage (Vgs2), the minimum voltage (V_FET) to drive the nMOSFET is lowered, and associated ON-resistance (Rds) is also lowered

The gate-source voltage of the nMOSFET to drive the heater may be adjusted by a separated driving power-supply signal (Vdda) applied to the pre-driver 33 of the heater driving circuit.

By the adjustment of the gate-source voltage of the nMOSFET driving the heater, the ON-resistance (Rds) of the nMOSFET is also lowered, so that a power-supply line resistance corresponding to several small-sized groups is changed as previously stated in FIG. 2.

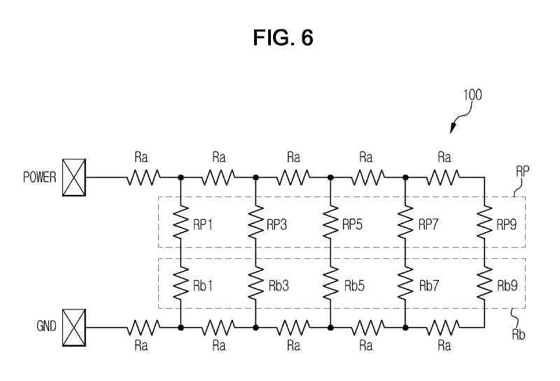

An additional resistor unit is connected to the small-sized group heater resistor unit so as to properly cope with the variation of the heater driving condition, and a detailed description thereof will hereinafter be described with reference to FIG. 6.

FIG. 6 is a modeling diagram illustrating a power-supply line resistance corresponding to a plurality of small-sized groups contained in a first large-sized group applied to a head-chip according to an embodiment of the present general inventive concept.

In FIG. 6, “Ra” is indicative of a wiring resistance between the small-sized groups, “RP” is indicative of a small-sized group heater resistor unit, and “Rb” is indicative of an additional resistor unit connected to the small-sized group heater resistor unit so as to implement addition of the wiring resistance.

The additional resistor unit “Rb” includes a plurality of small-sized group additional resistors (Rb1, Rb3, Rb5, Rb7, and Rb9), which correspond to heater sum resistors (RP1, RP3, RP5, RP7, and RP9) of the small-sized groups, respectively. The above-mentioned small-sized group additional resistors (Rb1, Rb3, Rb5, Rb7, and Rb9) are established by a driving power-supply signal of the pre-driver provided in the heater driving circuit corresponding to each additional resistor. Therefore, if the small-sized group additional resistors (Rb1, Rb3, Rb5, Rb7, and Rb9) are properly established, the heater sum resistance of the small-sized groups can be compensated, so that a constant heater driving current may flow in the additional resistors (Rb1, Rb3, Rb5, Rb7, and Rb9) irrespective of a number of driven heaters and heaters' relative location.

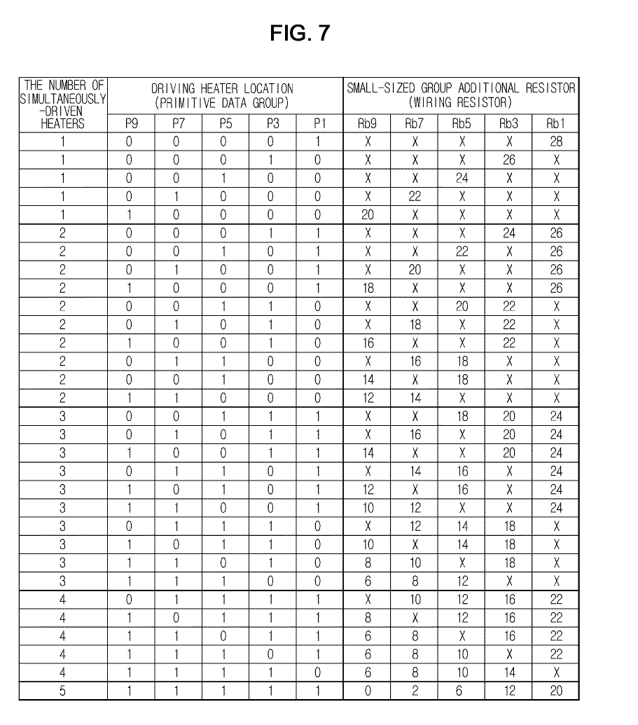

FIG. 7 exemplarily illustrates a process to establish additional resistances of a plurality of small-sized groups according to the number of simultaneously-driven heaters and locations of the heaters according to an embodiment of the present general inventive concept. In this case, the additional resistance of each small-sized group is not equal to a real resistance. If the wiring resistance (Ra) between the small-sized groups is set to “1”, the above-mentioned additional resistance numerically represents a relative index associated with the wiring resistance (Ra) having the value of “1”. In the case of establishing the additional resistance, there is needed a single reference. For example, if the several small-sized groups simultaneously drive a total of 5 heaters, additional resistors (Rb1, Rb3, Rb5, Rb7, and Rb9) of the several small-sized groups correspond to “20”, “12”, “6”, “2”, and “0”, respectively. The present general inventive concept can easily establish the additional resistance suitable for each condition on a basis of a relative resistance-ratio in consideration of the above-mentioned relationship.

In the meantime, the number of driven heaters and the heater location are determined according to the printing data received from the controller. If the additional resistance is fixed at a specific value, the fixed additional resistance cannot properly cope with the number of driven heaters and the heater location, thus, the additional resistance can be variable with the printing data.

The additional resistance must be properly established in consideration of the heater driving condition by referring to FIG. 7. That is, there is a need to variably establish the additional resistance according to a number of driven heaters and the heater location.

However, the additional resistance is not equally applied to all of head-chips due to characteristics of the head-chips, so that the additional resistance is required to be established after the head chip has been completely manufactured. And, there is a need to recognize/establish the additional resistance after the head chip has been manufactured.

The present embodiment includes a simulation driving circuit to perform a simulation test of the real heater driving circuit in the head chip, and establishes the additional resistance suitable for the number of driven heaters and the heater location using the simulation driving circuit.

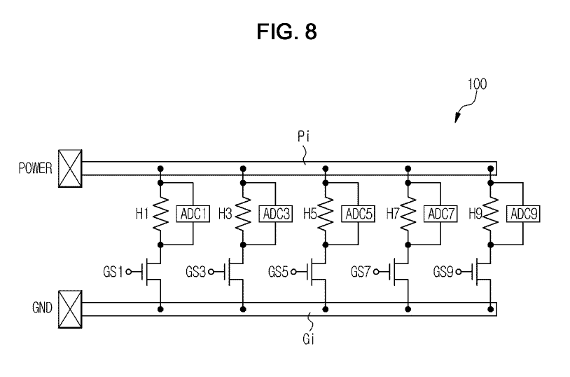

FIG. 8 is a modeling diagram illustrating a simulation driving circuit according to an embodiment of the present general inventive concept. In this case, the simulation driving circuit includes a power-supply wiring circuit to control a power-supply signal applied to the heater, a simulation power-supply wiring analyzer associated with the power-supply wiring circuit, a memory, and a decoder.

The simulation power-supply wiring circuit 100 has a same conceptual structure as the modeling of FIG. 6, so that the simulation power-supply wiring circuit 100 will be described by referring to the same reference numerals as the reference numerals of FIG. 6. Differently, FIG. 8 illustrates a plurality of heater resistors (H1, H3, H5, H7, and H9) and variable resistors (GS1, GS3, GS5, GS7, and GS9) each equal to a sum of an ON-resistance of the nMOSFET corresponding to each heater resistor and an additional resistor.

Analog-to-Digital Converters (ADC1, ADC3, ADC5, ADC5, and ADC9) to convert the heater driving current into digital data are connected in parallel to the heater resistors (H1, H3, H5, H7, and H9) of the small-sized groups, respectively.

The simulation power-supply wiring circuit 100 shares a power-supply wiring (POWER) and a ground wiring (GND). In this case, the power-supply wiring (POWER) and the ground wiring (GND) are configured by reducing a width and length of a real wiring by a predetermined ratio.

The simulation power-supply wiring circuit 100 controls an additional driving power-supply signal (Vdda) provided to the pre-driver 33 to apply an output voltage to the gate of the nMOSFET connected to each heater resistor (H1, H3, H5, H7, or H9) of the small-sized groups, so that the simulation power-supply wiring circuit 100 can test a process to establish the additional resistance.

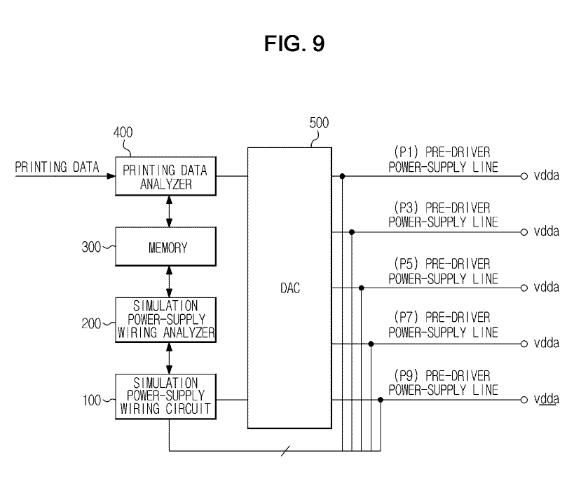

FIG. 9 is a block diagram illustrating an inkjet image forming apparatus according to an embodiment of the present general inventive concept.

Referring to FIG. 9, the simulation power-supply wiring circuit 100 applies a request to adjust a driving power-supply signal (Vdda) in consideration of the number of driven heaters and the heater location to a decoder (DAC) 500. In response to the request of the simulation power-supply wiring circuit 100, the decoder (DAC) 500 separately varies the driving power-supplysignal (Vdaa) provided to the pre-driver of the heater driving circuit of each small-sized group.

While the driving power-supply signal (Vdaa) provided to the pre-driver is separately varied, digital-formatted heater driving current information measured at the ADCs (ADC1, ADC3, ADC5, ADC7, and ADC9) of the simulation power-supply wiring circuit 100 is applied to the simulation power-supply wiring analyzer 200.

The simulation power-supply wiring analyzer 200 acquires appropriate additional resistance information associated with each case of FIG. 7 on a basis of the received heater driving current information. This additional resistance information is applied to the memory 300, so that the additional resistance information is stored in the memory 300.

The above-mentioned operation to store the additional resistance information acquired by the simulation driving circuit may be performed in a variety of cases, for example, a case in which a system receives an initial power-supply signal, a case in which a head chip is exchanged, or a case in which the head chip is repaired.

After the additional resistance information is stored in the memory, a printing data analyzer 400 receives printing data from the logic unit, analyzes the number of heaters required to print the printing data and the heater location, and reads information of the additional resistance stored in the memory 300 according to the analyzed result. And, the printing data analyzer 400 separately establishes the driving power-supply signal (Vdaa) applied to the pre-driver of each heater driving circuit of each small-sized group according to the read information, controls the switching-on operation of the corresponding nMOSFET, and performs the printing process.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, the inkjet image forming apparatus according to various embodiments of the present general inventive concept establishes additional resistance affected by a number of driven heaters and the heater location using a simulation driving circuit contained in a head chip, and properly compensates for a heater driving current to prevent negative influence on the ink-discharging characteristics, resulting in the implementation of a superior printing quality.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An inkjet image forming apparatus, comprising:
a heater driving circuit disposed on a head chip; and
a simulation driving circuit to compensate for a change of a heater driving condition based on one or more printer-head characteristics.

2. The apparatus according to claim 1, wherein the simulation driving circuit compensates for a difference in heater driving current flowing in each heater according to a number of simultaneously-driven heaters associated with the plurality of heaters and locations of the heaters.

3. The apparatus according to claim 2, wherein the simulation driving circuit is provided in the print-head chip.

4. The apparatus according to claim 2, wherein the simulation driving circuit varies a driving power-supply signal provided to a driver to drive a transistor connected to each heater in order to perform a simulation test.

5. The apparatus according to claim 4, wherein the transistor comprises:
an nMOSFET.

6. The apparatus according to claim 4, wherein the driving power-supply signal provided to the driver is located separately from a heater-driving power-supply signal to drive each heater.

7. The apparatus according to claim 6, wherein the driver changes a voltage signal applied to a gate of the nMOSFET according to the received driving power-supply signal.

8. The apparatus according to claim 4, wherein the simulation driving circuit comprises:
a simulation power-supply wiring circuit modeled on the heater driving circuit;
a decoder to change the driving power-supply signal, and to provide the changed driving power-supply signal;
a simulation power-supply wiring analyzer to generate specific information to establish a heater resistance and an additional resistance added to an ON-resistance of the transistor according to the number of simultaneously-driven heaters and the locations of the heaters, while the driving power-supply signal is changed; and
a memory to store information associated with the additional resistance.

9. The apparatus according to claim 8, wherein the simulation power-supply wiring circuit allows individual heater resistances corresponding to the heater to share a power-supply wiring and a ground wiring, and the power-supply wiring and the ground wiring are configured by reducing a width and a length of a real wiring by a predetermined ratio.

10. A method to control an inkjet image forming apparatus which includes a heater driving circuit to drive a plurality of heaters corresponding to a plurality of nozzles; and a simulation driving circuit contained in a head chip, to perform a simulation test using a specific circuit modeled on the heater driving circuit, the method comprising:
determining if a current mode is an operation mode; and
if the operation mode is determined, acquiring specific information of an additional resistance added to each heater, in order to compensate for a variation in heater driving condition which is changed according to a number of simultaneously-driven heaters corresponding to the plurality of heaters and locations of the heaters using the simulation driving circuit, and storing the acquired information of the additional resistance.

11. The method according to claim 10, wherein the determining of the operation mode comprises:
if the head chip is exchanged or repaired while an initial power-supply signal is provided to a system, determining the operation mode for the simulation test.

12. The method according to claim 10, wherein the acquiring of the additional resistance information comprises:
changing a driver's driving power-supply signal applied to a gate of an nMOSFET connected to the heater.

13. The method according to claim 12, further comprising:
establishing a driving power-supply signal of the driver according to the additional resistance read from information stored according to print data provided for a print process.

14. The apparatus of claim 1, wherein the simulation driving circuit compensates for the change of the heater driving condition by variably establishing additional resistance corresponding to a number of driven heaters and heater locations.

15. A method of operating an inkjet image forming apparatus, the method comprising:
identifying one or more printer-head characteristics; and
compensating for a change of a heater driving condition based on the identified one or more printer-head characteristics by variably establishing additional resistance corresponding to a number of driven heaters and heater locations.
